(19) United States
(12) Patent Application Publication
(10) Pub. No.: US 2008/0144124 A1
(43) Pub. Date: Jun. 19, 2008

(54) Auxiliary information for reconstructing digital images processed through print-scan channels

(76) Inventors: Ramin Samadani, Menlo Park, CA (US); Debargha Mukherjee, Sunnyvale, CA (US); Jian Fan, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/580,720

(22) Filed: Oct. 13, 2006

(51) Int. Cl. H04N 1/387

(52) U.S. Cl. 358/453

(57) ABSTRACT

Systems and methods of generating and using auxiliary information for reconstructing digital images that have processed through print-scan channels are described. Auxiliary information, including values of reference pixels, is extracted from an input image. Output image data containing a representation of the input image is generated. The auxiliary information is stored in association with the output image data. The auxiliary data structure is decoded to produce decoded auxiliary information. Scanned image data that is obtained from a hard copy of the output image data is registered and color-corrected based on the decoded auxiliary information to obtain an output image corresponding to a high-quality reconstruction of the input image. The auxiliary information may include coded transform coefficient data from which the input image may be reconstructed using the registered and color-corrected output image as side information.

### BACKGROUND

Printed images routinely are scanned into a digital format so that they can be manipulated by a computer. The resulting scanned images, however, differ from the original digital images that were used to create the printed images because of inherent imperfections in the print-scan channels. In particular, the process of printing a digital image to the physical domain and scanning the printed images back to the digital domain introduces distortions, errors, and other defects that appear in the scanned images.

Commercial software packages, such as Adobe Photoshop®, are available for correcting the distortions in scanned images that are introduced by print-scan channels. Most manual image reconstruction systems of this type, however, require a substantial investment of money, time, and effort before they can be used to manually reconstruct the original digital images from the corresponding scanned images. Even after a user has become proficient at using a manual image reconstruction system, the process of editing the scanned images typically is time-consuming and labor-intensive. Although some approaches for automatically reconstructing scanned image content have been proposed, these approaches typically use generic correction routines that are not capable of producing high-quality approximations to the original digital images.

What are needed are methods and systems that are capable of reconstructing high-quality approximations of digital images that have been processed through print-scan channels.

### SUMMARY

In one aspect, the invention features an image processing method in accordance with which auxiliary information, including values of reference pixels, is extracted from an input image. The auxiliary information is encoded into an auxiliary data structure. Output image data containing a representation of the input image is generated. In at least one physical storage medium, the auxiliary data structure is stored in association with the output image data.

In one aspect, the invention features an image processing method in accordance with which scanned image data is obtained from a hard copy of output image data containing an input image. An auxiliary data structure associated with the output image data is decoded to produce decoded auxiliary information. Locations of corners of the input image in the scanned image data are estimated. The scanned image data within the estimated corner locations is warped to obtain sample points in the scanned image data. The portion of the scanned image data within the estimated corner locations is registered based on correspondences between the reference pixel values in the decoded auxiliary information and values of sample points at corresponding locations in the scanned image data. A color transform is derived between ones of the reference pixel values in the auxiliary data structure and values of corresponding ones of the sample points of the registered image. The color transform is applied to the registered image to obtain a color-corrected image.

In another aspect, the invention features an image processing system that includes an auxiliary information processing component, an encoding processing component, and an output image processing component. The auxiliary information processing component extracts auxiliary information, including values of reference pixels, from an input image. The encoding processing component encodes the auxiliary information into an auxiliary data structure. The output image processing component generates output image data containing a representation of the input image. At least one of the encoding processing component and the output image processing component stores the auxiliary data structure in association with the output image data in at least one physical storage medium.

Other features and advantages of the invention will become apparent from the following description, including the drawings and the claims.

### DESCRIPTION OF DRAWINGS

FIG. 1 is a block diagram of an embodiment of an input image processing system and an embodiment of a scanned image reconstruction system in an exemplary application environment.

FIG. 2 is a flow diagram of an embodiment of an input image processing method.

FIG. 3 is a block diagram of an embodiment of an auxiliary information processing component.

FIG. 4A is a diagrammatic view of an exemplary input image over which is superimposed a set of block boundaries demarcating a corresponding set of regularly spaced blocks of pixels across the input image.

FIG. 4B is a diagrammatic view of the input image shown in FIG. 4A over which is superimposed a set of boundaries demarcating a corresponding set of regularly spaced pixel sample points across the input image.

FIG. 5 is a flow diagram of an embodiment of a method of encoding an input image.

FIG. 6 shows a distribution of transform coefficients, a probability mass function for a set of the quantized transform coefficients, and a probability mass function of the coset indices derived from the quantized transform coefficients in accordance with an embodiment of the invention.

FIG. 7 is a schematic diagram of an embodiment of a method of coding block transforms.

FIG. 8 is a flow diagram of an embodiment of a scanned image processing method.

FIG. 9 is a flow diagram of an embodiment of a method of registering an input image portion of scanned image data.

FIG. 10 shows a distribution of transform coefficients, a probability distribution, and an example of the decoding of a coset index in accordance with an embodiment of the invention.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale. Elements shown with dashed lines are optional elements in the illustrated embodiments incorporating such elements.

### I. Introduction

In accordance with the embodiments that are described in detail herein, auxiliary information is extracted from digital input images. The auxiliary information describes or otherwise captures reference features of the input images. The auxiliary information is used in reconstructing ones of the input images that have been processed through print-scan channels. As explained in detail below, the auxiliary information allows these embodiments to reconstruct high-quality approximations of the original digital input images.

### II. Overview of an Input Image Processing System and a Scanned Image Processing System in an Exemplary Application Environment

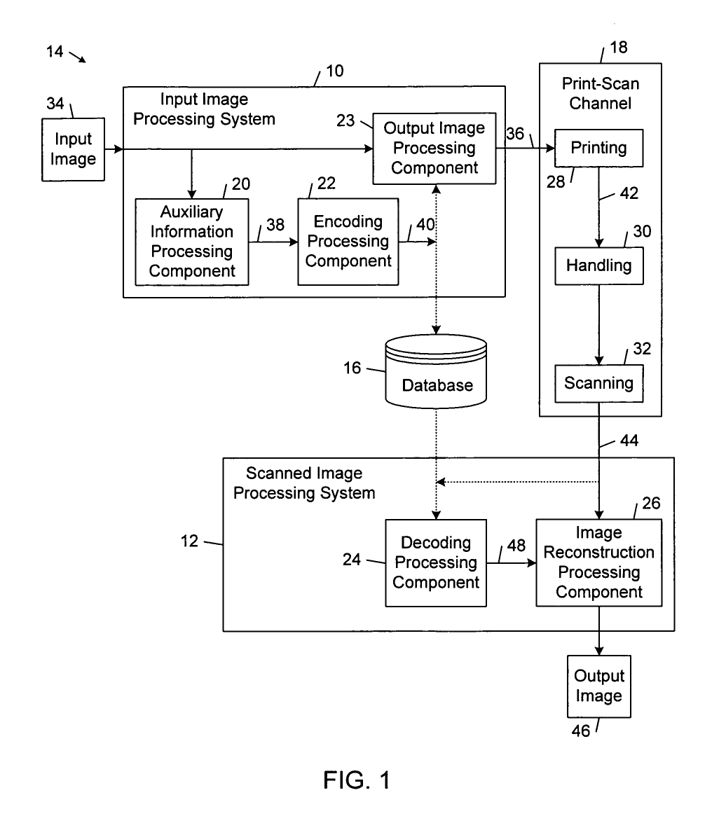

FIG. 1 shows an embodiment of an input image processing system 10 and a scanned image processing system 12 in an exemplary application environment 14 that includes a database 16 and a print-scan channel 18. The input image processing system 10 includes an auxiliary information processing component 20, an encoding processing component 22, and an output image processing component 23. The scanned image processing component 12 includes a decoding processing component 24 and an image reconstruction processing component 26. The print-scan channel 18 includes a print stage 28, a document handling stage 30, and a scanning stage 32.

In operation, the input image processing system 10 processes a digital input image 34 to generate output image data 36 that is passed to the printing stage 28 of the print-scan channel 18. The input image 20 may correspond to any type of digital image, including an original image (e.g., a video keyframe, a still image, or a scanned image) that was captured by an image sensor (e.g., a digital video camera, a digital still image camera, or an optical scanner) or a processed (e.g., sub-sampled, filtered, reformatted, enhanced or otherwise modified) version of such an original image.

In the course of processing the input image 34, the auxiliary information processing component 20 extracts from the input image 34 auxiliary information 38 that describes or otherwise captures reference features of the input image 34. The encoding processing component 22 encodes the auxiliary information 38 into an auxiliary data structure 40 (e.g., a table, a list, or a set of encoded feature vectors). In some embodiments, the encoding processing component 22 stores the auxiliary data structure 40 in the database 16, which includes an index containing an identifier (e.g., a label, or an address, such as a uniform resource identifier (URI)) that allows the auxiliary data structure 40 to be retrieved using the identifier as an index into the database 16. In these embodiments, the output image processing component 23 incorporates the identifier of the auxiliary data structure 40 into the output image data 36. In other embodiments, the encoding processing component 22 passes the auxiliary data structure 40 to the output image processing component 23, which incorporates the auxiliary data structure 40 into the output image data 36.

In the print-scan channel 18, the output image data 36 is converted into one or more hard copies 42 by the printing stage 28. Some time after the hard copies 42 of the output image data 36 have been printed, the hard copies 42 are processed through the handling stage 30 before being converted into an electronic scanned image data 44 by the scanning stage 32.

The output image data 36 may be printed by a conventional printer (e.g., a LaserJet® printer available from Hewlett-Packard Company of Palo Alto, Calif., U.S.A.) or a special-purpose label printing device. The hard copies 42 may be in the form of any one of a wide variety of printed materials, including a photographic print, a bank draft (or check) carrying a graphical bar code of a withdrawal authorization signature, a stock certificate or bond carrying a graphical bar code of an authenticity certification, and an envelope carrying a graphical bar code of postage indicia. In embodiments in which the auxiliary data structure 40 is incorporated in the output image data 36, the auxiliary data structure 40 may be encoded in the printed image data (e.g., in a one- or two-dimensional bar code, a graphical bar code, or a watermark). In some of these embodiments, the portion of the output image data 36 corresponding to the auxiliary data structure 40 is printed on the opposite side of a print medium (e.g., a sheet of paper) as the portion of the output image data 36 corresponding to the input image 34.

After passing through the handling stage 30, the hard copies 42 may be scanned by a high quality desktop optical scanner. In general, the resolution of the scanner should at least match the resolution at which the output image data 36 is printed so that the details in the one or more hard copies 42 can be resolved. The scanning resolution typically depends on the pixel count (e.g., 5 Mega-pixels) on the input image 34 and the physical print size (e.g., 4 inches by six inches). A scanning resolution of 600 dots per inch (dpi) typically is sufficient for the scanned image processing system 12 to properly reconstruct the input image 34 from a typical hard copy of the output image data 36. The scanning stage 32 passes the scanned image data 44 to the scanned image processing system 12 for processing. The scanned image data 44 that is acquired by the scanned image processing system 12 is a degraded version of the original input 34. These degradations may be generated at one or more of the stages the print-scan channel 18, including the printing stage 28 (e.g., color distortions), the handling stage 30 (e.g., copying degradations, stains, folds, staples, and markings), and the scanning stage 32 (e.g., color distortions and registration distortions).

The scanned image processing system 12 processes the scanned image data 44 to generate an output image 46 that corresponds to a high-quality approximation of the input image 34. In the course of processing the scanned image data 44, the decoding processing component 24 retrieves the encoded auxiliary data structure 40 from either the database 16 or the scanned image data 44 and decodes the auxiliary data structure 40 to produce decoded auxiliary information 48. As explained in detail below, the image reconstruction processing component 26 uses the decoded auxiliary information 48 in the process of producing the output image 46 from the scanned image data 44.

In general, each of the input image processing system 10 and the scanned image processing system 12 may be implemented by one or more discrete processing components (or modules) that are not limited to any particular hardware, firmware, or software configuration. In the illustrated embodiment, the processing components 20, 22, 23, 24, 26 may be implemented in any computing or data processing environment, including in digital electronic circuitry (e.g., an application-specific integrated circuit, such as a digital signal processor (DSP)) or in computer hardware, firmware, device driver, or software. In some embodiments, the functionalities of multiple ones of the processing components 20, 22, 23, 24, 26 are combined into a single processing component. In some embodiments, the respective functionalities of each of one or more of the processing components 20, 22, 23, 24, 26 are performed by a respective set of multiple processing components.

In some implementations, computer process instructions for implementing the methods that are executed by the input image processing system 10 and the scanned image processing system 12, as well as the data they generate, are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

### III. Exemplary Embodiments of the Input Image Processing System and its Components

A. Introduction

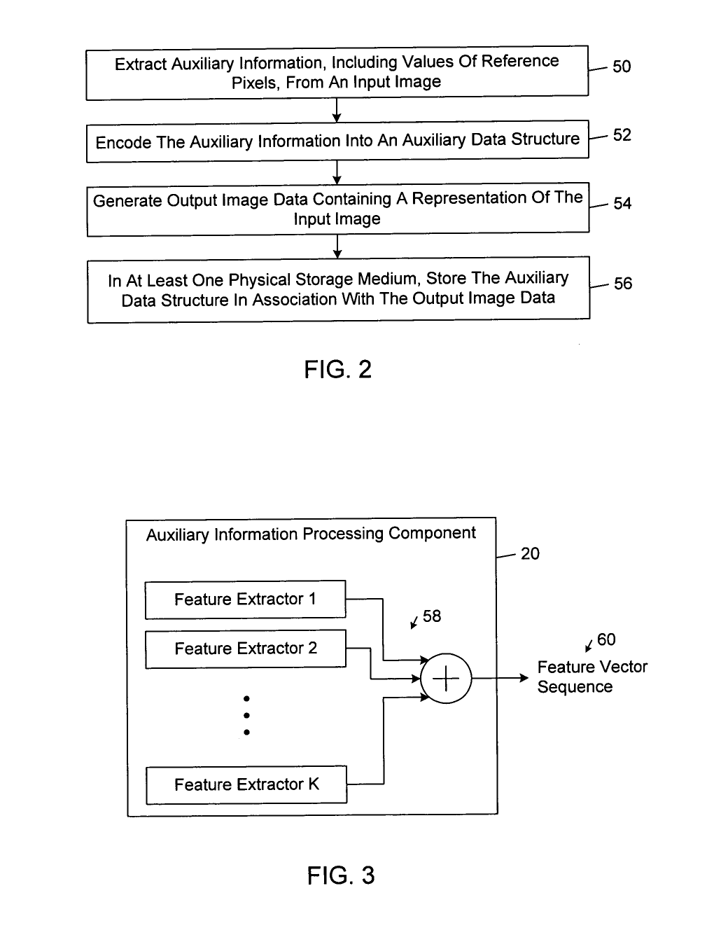

FIG. 2 shows an embodiment of a method that is implemented by the input image processing system 10. In accordance with this method, the auxiliary information processing component 20 extracts the auxiliary information 38, including values of reference pixels, from the input image 34 (FIG. 2, block 50). The encoding processing component 22 encodes the auxiliary information 38 into the auxiliary data structure 40 (FIG. 2, block 52). The output image processing component 23 generates the output image data 36 that contains a representation of the input image 34 (FIG. 2, block 54). At least one of the encoding processing component 22 and the output image processing component 23 stores the auxiliary data structure 40 in association with the output image data 36 in at least one physical storage medium (FIG. 2, block 56). The at least one physical storage medium may be at least one of an electronic memory device (e.g., a computer-readable storage medium) or a collection of one or more print media (e.g., sheets of paper).

B. Extracting Auxiliary Information from the Input Image

The auxiliary information processing component 20 extracts the auxiliary information 38, including values of reference pixels, from the input image 34 (FIG. 2, block 50; see FIG. 1). In general, the auxiliary information 38 includes any information that can be extracted from the digital input image 34 and used to assist in reconstructing an approximation of the digital input image 34 from the scanned image data 44 that results from processing the output image data 36 through the print-scan channel 18.

FIG. 3 shows an embodiment of the auxiliary information processing component 20 that includes a set of K feature extractors, where K has an integer value of at least one. Each of the feature extractors extracts values corresponding to a respective reference feature of the digital input image 34. In the illustrated embodiment, the extracted values are output in the form of a set of K feature vectors 58 that are combined into a feature vector sequence 60, which is included in the auxiliary information 38.

Exemplary reference features include horizontal and vertical pixel dimensions of the digital input image 34, a physical print size for the one or more hard copies 42 of the input image 34 that is specified by the output image processing component 23 to the printing stage 28 of the print-scan channel 18, and values of one or more selected reference pixels of the input image 34. Multi-resolution reference information is also a possibility, where averages of regions of the input image, at different spatial resolutions, are the features. The pixel dimensions of the digital input image 34 typically are extracted from a header or start of frame segment that is associated with the electronic file (e.g., JPEG file) in which the digital input image 34 is stored. The physical print size of the input image 34 typically is specified to the output image processing component 23 by a user of the input image processing system 10 or by some other external source. The reference pixels typically are pixels of the input image 34 that have locations that can be identified by their pixel coordinate values or by their values in relation to the values of neighboring pixels.

In some embodiments, the values of reference pixels at regularly spaced locations across the input image 34 are incorporated into one or more feature vectors that are included in the auxiliary information 38. If the locations of the reference pixels are known or can be determined independently by the scanned image processing system 12, a specification of these locations need not be included in the auxiliary information 38. On the other hand, if the locations of the reference pixels are not known and cannot be determined independently by the scanned image processing system 12, a specification of these reference pixel locations is included in the auxiliary information 38.

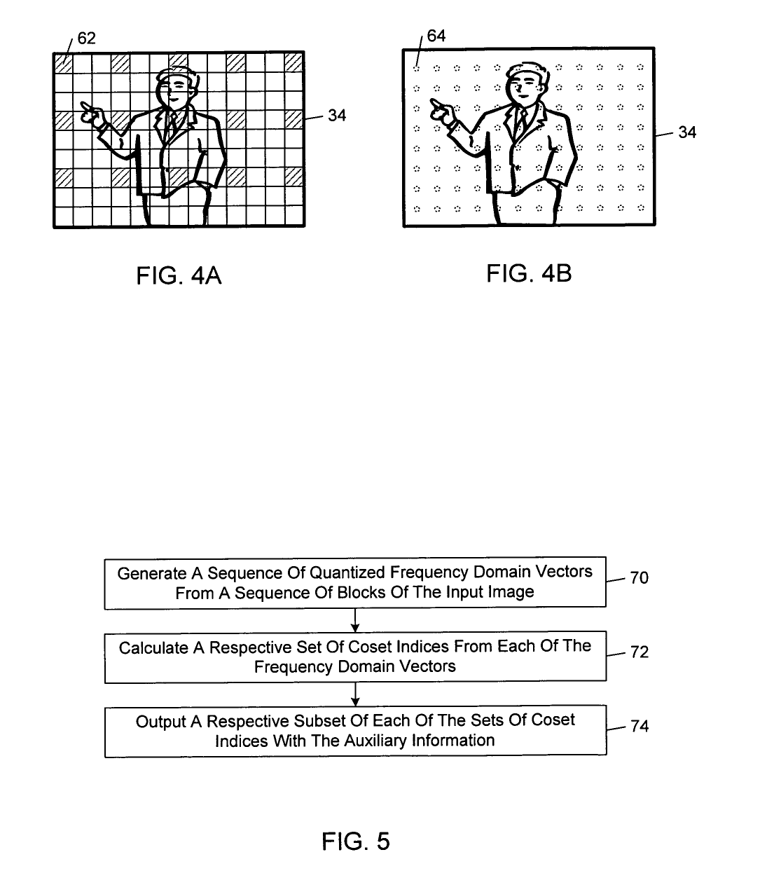

As shown in FIG. 4A, the reference pixels may correspond to the pixels in blocks 62 (indicated by cross-hatching) that are distributed at regularly spaced locations across the input image 34. In general, each of the pixel blocks 62 has a size of A pixel high by B pixels wide, where A and B have integer values of at least one and at least one of A and B has a value of at least two. In some embodiments, the luminance values (e.g., the luminance values of the YCrCb color space) of pixels within blocks at regularly spaced locations across the input image 34 are selected to form a feature vector that is included in the auxiliary information 38. As shown in FIG. 4B, the reference pixels also may correspond to individual pixels at regularly spaced pixel locations 64 that are distributed across the input image 34. In some embodiments, the color values (e.g., the RGB values in the RGB color space or the red and blue chrominance values in the YCrCb color space) of pixels at regularly spaced pixel locations across the input image 34 are selected to form one or more of the feature vectors 58 that are included in the auxiliary information 38.

In some embodiments, reference pixels of the input image 34 are identified by ones of the feature extractors that are implemented by respective interest operators, which identify reference pixels based on their values in relation to the values of neighboring pixels. In these embodiments, the values and locations of the identified reference pixels typically form one or more of the feature vectors 58 that are included with the auxiliary information 28. In general, any type of interest operator may be used to select reference pixels. In some embodiments, one or more registration interest operators are used to identify registration reference pixels whose values serve as landmarks for registering the scanned image data 44. In some embodiments, one or more color-correction interest operators are used to identify color reference pixels whose values serve a color references for color-correcting the scanned image data 44.

Registration interest operators typically are designed to identify salient features of the input image 34. In some embodiments, the auxiliary information processing component 20 identifies high saliency regions (e.g., blocks) of the input image that are associated with locally unique visual features (e.g., corners, texture, edges, and other structural elements) by applying one or more registration interest operators to the input image 34. In general, any one or more of a wide variety of different types of registration interest operators may be used for this purpose. The registration interest operators may be statistical, structural, or syntactic. The registration interest operators may identify high saliency regions based on the detection of one or more of: the level of contrast in the input image 34; the magnitude (amplitude) of pixel values in the input image 34; the energy of pixel values in the input image 34; the variance of pixel values in the input image 34; the skewness of the gradient value distribution in the input image; and the edge frequency in the input image. Exemplary registration interest operators include corner detection interest operators (e.g., luminance variance based interest operators, such as the Moravec interest operator, and autocorrelation based interest operators, which identify peaks in an autocorrelation function that is applied to local regions across the input image 34) and scale-invariant feature transforms (SIFTs). The registration interest operators may be applied to individual pixels, local regions (e.g., blocks of pixels), or all of the pixels of the input image 34.

Some color-correction interest operators identify pixels with color values that span the color gamut volume for the input image 34. In some of these embodiments, the color-correction interest operators identify pixels in low-texture regions of the input image 34. Any of a wide variety of different texture-sensitive interest operators may be used to identify low-texture regions of the input image 34 and select color reference pixels in the identified low-texture regions.

In some embodiments, the auxiliary information processing component 20 additionally includes in the auxiliary information 38 coded transform coefficients that are extracted from the input image 34. In these embodiments, the coded transform coefficients represent a distorted version of input image 34 that can be reconstructed into a high-quality approximation of the input image 34 by the scanned image processing system 12 using the scanned image data 44 as side information. In some of these embodiments, the coded transform coefficients are generated from the input image 34 in accordance with a Wyner-Ziv source coding process and used to produce the output image 46 in accordance with the corresponding Wyner-Ziv side information decoding process.

FIG. 5 shows an embodiment of a method that is executed by the auxiliary information processing component 20 to generate the coded transform coefficients. In accordance with this method, the auxiliary information processing component 20 generates a sequence of quantized frequency domain vectors from a sequence of blocks of the input image (FIG. 5, block 70). The auxiliary information processing component 20 calculates a respective set of coset indices from each of the frequency domain vectors (FIG. 5, block 72). The auxiliary information processing component 20 outputs a respective subset of each of the sets of coset indices with the auxiliary information 38 (FIG. 5, block 74).

In some embodiments, the input image 34 is divided into a population of N image blocks, where N has a positive integer value. In some implementations, the input image 34 is decomposed into image blocks of 8×8 pixels by a raster-to-block converter, which may be incorporated within the auxiliary information processing component 20 or may be a separate processing component of the input image processing system 10.

A forward transform module of the auxiliary information processing component 20 generates frequency domain vectors from respective ones of the image blocks. Each frequency domain vector contains a respective set of transform coefficients that is derived from a respective one of the image blocks. The frequency domain vectors correspond to the spatial frequency information in the input image. In general, the forward transform module may apply any kind of block transform to the image blocks. Exemplary types of block transforms include the cosine transform, Fourier transform, Hadamard transform, Haar wavelet transform, and wavelet-based decomposition transforms.

After computing the transform, the coefficients are quantized and then encoded into respective coset indices. In some embodiments, the auxiliary information processing component 20 encodes the quantized transform coefficients by computing cosets of odd modulus with indices that are centered at zero. For example, if x is a coefficient and its quantized value is given by q=φ(x,Q) based on the quantization step Q possibly with a dead zone, then the coset index c=ψ(q,M) of order M is computed in accordance with equation (1):

$$ψ ( q , M ) = \{ \begin{matrix} q - M ⌊ q / M ⌋ , & q - M ⌊ q / M ⌋ < M / 2 \\ q - M ⌊ q / M ⌋ - M , & q - M ⌊ q / M ⌋ \geq M / 2\end{matrix} \qquad ( 1 )$$

Assuming the distribution of x is a generalized Gaussian distribution (e.g., a Laplacian distribution), the probability mass function of q is geometric-like. Specifically, if xₗ(q) and xₕ(q) denote the low and high-limits of the quantization bin q, where q∈Ω={−qₘₐₓ, −qₘₐₓ+1, . . . , −1,0,1, . . . qₘₐₓ −1, qₘₐₓ}, then the probability of the q^{th} bin:

p_{Q}(q)=∫ₓ_{ₗ}_{(q)}^{x}^{ₕ}^{(q)}f_{X}(x)dx (2)

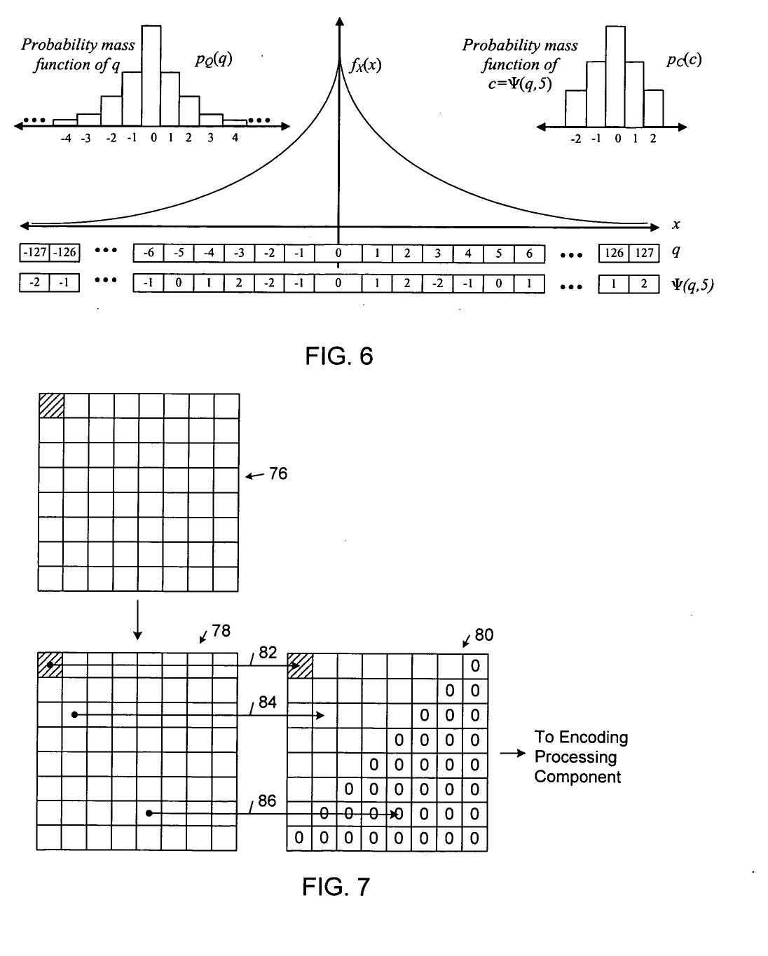

As shown in FIG. 6, the probability mass function p_{c}(c) for the coset indices ψ(q, M) for odd M is considerably flatter than the probability mass function p_{Q}(q) of the quantized coefficients q, but it is still symmetric, has zero as its mode, and decays with increasing magnitude. Specifically,

$${p}_{C} ( c ) = {\sum }_{q ∈ Ω : ψ ( q , M ) = c} {\int }_{{x}_{l} ( q )}^{{x}_{h} ( q )} {f}_{x} ( x ) d x \qquad ( 3 )$$

This feature allows the coset indices to be coded efficiently by a standard JPEG entropy coder, which may be included in some embodiments of the encoding processing component 22. However, better performance would be achieved by use of a different entropy coder, which specifically uses knowledge of M to constrain the size of the alphabet to be transmitted.

In some embodiments, only a subset of all non-zero coset indices of a transform block are included in the auxiliary data structure 40. In particular, only a few of the low frequency coefficients are sent for each block, while the rest are left to be recovered entirely from the side-information generation operation that is performed by the downstream scanned image processing system 12. The number of coefficients, which are transmitted in zigzag scan order, is denoted n. Additionally, the quantization step size Q that is used in computing q, as well as the value of M that is used in computing the coset index ψ(q,M), are varied for every coefficient in a block. The step sizes and moduli are referred to as Qᵢⱼ and Mᵢⱼ, respectively, where i, j=0, 1, . . . , B−1, B, where B is the block size. The highest frequencies are quantized more heavily than the quantization parameter corresponding to the quantity desired and encoded with smaller values of the coset modulus Mᵢⱼ. For the dc coefficient, only the true value without coset computation is output with the auxiliary information 38. The coefficients for the chrominance components also are coded similarly, but usually fewer coefficients than the luminance component are transmitted.

For decoding, the minimum squared error (MSE) reconstruction for each coefficient based on unquantized side information y and received coset index c is given by:

$$\begin{matrix}\hat{x} = E ( x / y , ψ ( φ ( x , Q ) , M ) = c ) \\ = \frac{{\sum }_{q ∈ Ω : ψ ( q , M ) = c} {\int }_{{x}_{l} ( q )}^{{x}_{h} ( q )} {xf}_{X / Y} ( x , y ) d x}{{\sum }_{q ∈ Ω : ψ ( q , M ) = c} {\int }_{{x}_{l} ( q )}^{{x}_{h} ( q )} {f}_{X / Y} ( x , y ) d x}\end{matrix} \qquad ( 4 )$$

An appropriate model for the correlation between X and the side information Y is assumed in order to evaluate the conditional distributions f_{x/y}(x,y) above. As mentioned before, transform coefficients X can be closely approximated by the Laplacian distribution (generalized Gaussian with parameter 1), while the side information can be modeled as Y=X+Z, where Z is assumed to be i.i.d. Gaussian uncorrelated with X. If the variance of X is σₓ² and that of Z is σ_{z}², the above optimal reconstruction function can be readily computed approximately based on polynomial approximations to the erf( ) function.

In general, the parameters Qᵢⱼ and Mᵢⱼ should be optimally chosen based on expected values σ_{x,ij} and σ_{z,ij} for the ij^{th} coefficient frequency. In some embodiments such an optimal choice is made based on expectation of the variances for the data, and that of the noise for a certain quality scanner expected to be used in the future during decoding. Often, this boils down to choosing a quantization parameter QPᵢⱼ and coset modulus Mᵢⱼ, given a target quality corresponding to the regular (non Wyner-Ziv) coding with quantization parameter QPᵢⱼ*.

FIG. 7 shows an exemplary embodiment of the transform coefficient transform encoding process of FIG. 5. In this embodiment, the forward transform module applies an 8×8 DCT to compute the transform coefficients 76 for each image block. In this illustrative example, the cross-hatched blocks correspond to the dc transform coefficient, the gray-filled blocks correspond to the transform coefficients that are mapped to non-zero coset values, and the white-filled blocks correspond to the transform coefficients that are mapped to zero coset values. The quantization module quantizes the forward transform coefficients to produce the quantized transform coefficients 78. In this process, the quantization parameter QPᵢⱼ that is used for the ij^{th} transform coefficient xᵢⱼ is given by: QPᵢⱼ=f_{Qp}(QP*ᵢⱼ, σ_{x,ij}, σ_{z,ij}), while the optimal coset modulus is given by Mᵢⱼ=f_{M}(QP*ᵢⱼ, σ_{x,ij}, σ_{z,ij}) where f_{Qp} and f_{M} represents the optimal parameter choice functions for QP and M respectively. Further, the number of coefficients n transmitted in zigzag order also becomes a function of these parameters, indirectly since after a certain frequency the optimal choice of M becomes 1, which is equivalent to not sending any data for that coefficient. In general, this can be viewed as n=fₙ({QP*ᵢⱼ}, {σ_{x,ij}}, {σz,ij}), where the function fₙ depends on all the target quantization parameters and variances in the block.

In some embodiments, blocks can be further classified into one of several types s={0, 1, 2, . . . , S−1} based on an estimate of how close the side information block received by the scanned image processing system 12 is likely to match the original image block. Various cues derived from the input image 34 can be used for this purpose. In some of these embodiments, the auxiliary information processing component 20 uses an edge activity measure to classify a block into one of S classes. Each block class along with each frequency would now correspond to a pair of variances {σ_{x,ij} (s), σ_{z,ij}(s)} based on which the parameters QPᵢⱼ(s) amd Mᵢⱼ(s) may be chosen for a given target quality corresponding to quantization parameter QP*ᵢⱼ. The classification index also yields n(s), and the number of coefficients that are output in zigzag scan order with the auxiliary information 38 while the rest of the coefficients are transmitted as zero.

The block 80 of coset indices is computed by copying the dc transform coefficient (as shown by arrow 82), mapping the quantized transform coefficients to the coset indices (as shown by arrow 84), and zeroing coset indices of the identified set of higher-frequency quantized transform coefficients (as shown by arrow 86).

C. Encoding the Auxiliary Information into the Auxiliary Data Structure

The encoding processing component 22 encodes the auxiliary information 38 into the auxiliary data structure 40 (FIG. 2, block 52; see FIG. 1).

In some embodiments, the auxiliary information 38 is passed from the auxiliary information processing component 20 to the encoding processing component 22 in the form of a sequence 60 of feature vectors 58, where each feature vector contains a set of related values. For example, respective feature vectors may contain values for the pixel dimensions of the input image 34, the specified print size (e.g., height and width) of the input image 34, pixel values extracted from the input image by respective feature extractors, and coded transform coefficients (e.g., coset indices).

The encoding processing component 22 encodes the auxiliary information 38 into the auxiliary data structure 40 using one or more encoding methods. In some embodiments, the feature vectors 58 are compressed in accordance with a conventional compression algorithm and encoded with an error correction code. Error correction coding provides robustness to errors due to degradations introduced by print-scan channel 18. The error correction codes also may be interleaved to protect against burst errors. In some embodiments, at least one of the feature vectors 58 (i.e., the feature vector containing the coded transform coefficients) are encoded in accordance with an entropy encoding technique (e.g., Huffman coding and arithmetic coding).

D. Storing the Auxiliary Data Structure in Association with the Output Image Data

At least one of the encoding processing component 22 and the output image processing component 23 stores the auxiliary data structure 40 in association with the output image data 36 in at least one physical storage medium (FIG. 2, block 56). As used herein, the auxiliary data structure 40 being stored “in association with” the output image data 36 in at least one physical storage medium means that that the auxiliary data structure 40 is physically or electronically, or both physically and electronically, linked to the output image data 36 in a way that allows the auxiliary data structure 40 to be retrieved from a hard copy of the output image data 36.

In some embodiments, the encoding processing component 22 stores the auxiliary data structure 40 in the database 16 in a way that allows the auxiliary data structure 40 to be retrieved using an identifier (e.g., a label or, or an address, such as a uniform resource identifier (URI)) that is assigned to the auxiliary data structure 40. In these embodiments, the output image processing component 23 incorporates the identifier in the output image data 36 so that the scanned image processing system 12 can retrieve the identifier from the scanned image data 44 and use the retrieved identifier to retrieve the auxiliary data structure 40 from the database 16 during reconstruction of the scanned image data 44.

In other embodiments, the output image processing component 23 merges the input image 34 and the auxiliary data structure 40 into the output image data 36, which is stored in a computer-readable storage medium. In these embodiments, the output image data 36 represents a layout of the input image 34 and the auxiliary data structure 40 on one or more pages of print media. The layout may present the input image 34 and the auxiliary data structure 40 on the same side of a single sheet of print medium, on opposite sides of a single sheet of print medium, or on different sheets of print media. In some embodiments, the encoding processing component 22 produces the output image data 36 based on a modulation of the input image 34 in accordance with a graphical encoding the auxiliary data structure 40. Exemplary graphical encoding processes are described in U.S. Pat. Nos. 6,751,352 and 6,722,567. The auxiliary data structure 40 may be graphically encoded into the visual representation of the input image 34 in the form of a binary image (e.g., a dark and bright dot pattern), a multilevel image (e.g., a gray-level image), or a multilevel color image. In other embodiments, the encoding processing component 22 encodes the auxiliary data structure 40 in the graphical design of text, borders, or the background surrounding the input image 34, or in a one- or two-dimensional bar code.

### IV. Exemplary Embodiments of the Scanned Image Processing System and its Components

A. Introduction

As explained above, the scanned image processing system 12 reconstructs a high-quality approximation of the original digital input image 34 based on the scanned image data 44 and the auxiliary data structure 40 that is stored in association with the output image data 36 (see FIG. 1).

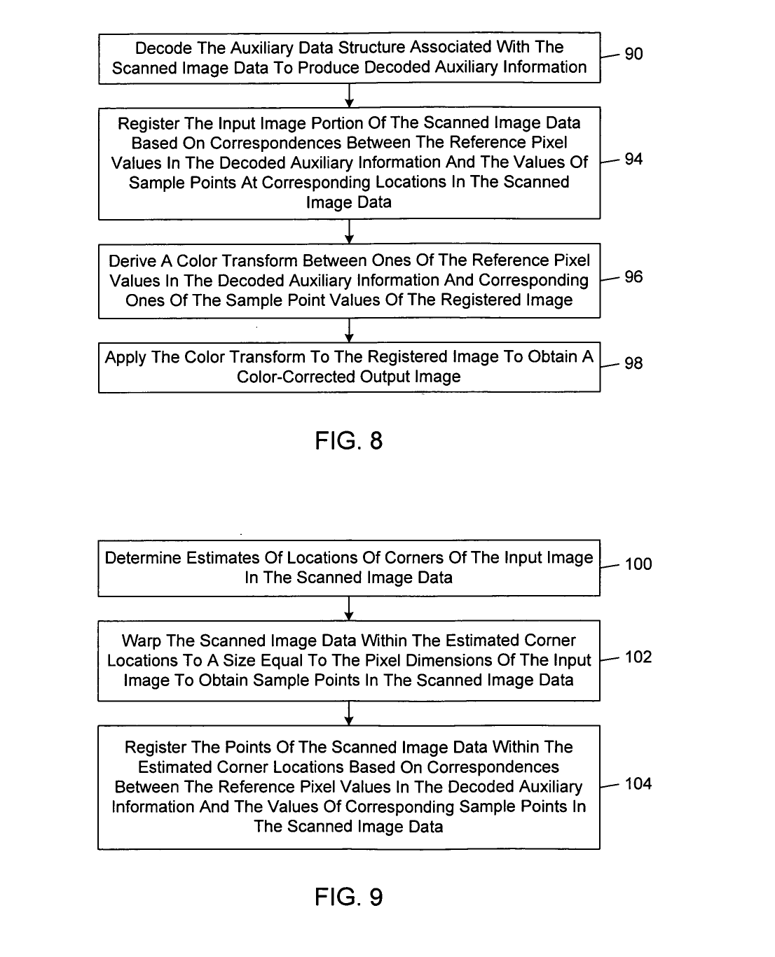

FIG. 8 shows an embodiment of a method that is implemented by the scanned image processing system 12 to reconstruct the input image 34 from the scanned image data 44 and the auxiliary data structure 40. In accordance with this method, the decoding processing component 24 decodes the auxiliary data structure that is associated with the scanned image data 44 to produce the decoded auxiliary information 48 (FIG. 8, block 90). The image reconstruction processing component 26 registers the input image portion of the scanned image data 44 based on correspondences between the reference pixel values in the decoded auxiliary information 38 and the values of sample points at corresponding locations in the scanned image data 44 (FIG. 8, block 94). The image reconstruction processing component 26 derives a color transform between ones of the reference pixel values in the decoded auxiliary data structure and values of corresponding ones of the sample points of the registered image (FIG. 8, block 96). The image reconstruction processing component 26 applies the color transform to the registered image to obtain a color-corrected output image 46 (FIG. 8, block 98).

In some embodiments, the registration and color-correction processes (FIG. 8, blocks 94, 96, 98) are repeated for a specified number of iterations before the output image 46 is output from the reconstruction processing component 26. At the end of each iteration, before the input image portion of the scanned image data 44 is registered, all the scanned image data 44 is color-transformed using the same color transform that was applied to the registered image in block 98 (FIG. 8, block 94).

B. Preprocessing the Scanned Image Data

Some embodiments of the scanned image processing system 12 include a pre-processing stage that locates in the scanned image data 44 the scanned version of the input image 34 and, if present, the scanned version of the auxiliary data structure 40. The pre-processing stage typically crops and trims the input image and auxiliary data structure portions from the scanned image data 44, and performs an initial registration (e.g., deskewing) of the trimmed portions of the scanned image data 44 before passing the resulting image data to the image reconstruction processing component 26 and, if necessary, to the decoding processing component 24. In addition, the preprocessing stage typically determines estimates of the locations of the corners of the input image in the scanned image data 44. An exemplary quadrilateral detection method, which may be used to provide an initial estimate of the corner locations of the input image in the scanned image data 44, is described in U.S. Patent Application Publication No. 2005/0169531, which is incorporated herein by reference.

C. Decoding the Auxiliary Data Structure Asscociated with the Scanned Image Data

In response to receipt of the scanned image data 44, the decoding processing component 24 locates the auxiliary data structure 40 that is associated with the output image data 36. As explained above, the auxiliary data structure 40 may be associated with the output image data 36 by an identifier that was incorporated in the output image data 36 or by a merger of the auxiliary data structure 40 into the output image data 36. If the decoding processing component 24 locates an identifier in the scanned image data 44, the decoding processing component 24 retrieves the auxiliary data structure 40 from the database 16 by querying the database 16 for an entry corresponding to the identifier. If the decoding processing component 24 locates a representation of the auxiliary data structure 40 in the scanned image data 44, the decoding processing component 24 extracts the auxiliary data structure using a type of extraction process that depends on the process that was used to represent the auxiliary data structure 40 in the scanned image data 44. For example, if the auxiliary data structure is represented by a one- or two-dimension bar code, the decoding processing component 24 may extract the auxiliary data structure using a corresponding bar code reading method. If the auxiliary data structure is graphically encoded in the scanned image data, the decoding processing component 24 may extract the auxiliary data structure using a corresponding graphical decoding process.

After obtaining the auxiliary data structure 40, the decoding processing component 24 decodes the auxiliary data structure to obtain the decoded auxiliary information 48. The decoding processing component 24 typically produces the decoded auxiliary information 48 by reversing the process that was used by the encoding processing component 22 to encode the auxiliary information 38 into the auxiliary data structure 40. The decoding processing component 24 passes the decoded auxiliary information 48 to the image reconstruction processing component 26.

D. Registering the Input Image Portion of the Scanned Image Data

FIG. 9 shows an embodiment of a method that is executed by the image reconstruction processing component 26 to register the input image portion of the scanned image data 44.

In accordance with this embodiment, after any initial preprocessing of the scanned image data 44, the image reconstruction processing component 26 determines estimates of the locations of corners of the input image in the scanned image data 44 (FIG. 9, block 100). The image reconstruction processing component 26 may determined the corner location estimates from the data received from the preprocessing data or it may determine the corner location estimates by applying a corner locating process, such as the quadrilateral detection process mentioned above, to the scanned image data 44.

The image reconstruction processing component 26 warps the scanned image data 44 within the estimated corner locations to a size that is equal to the pixel dimensions of the input image 34 to obtain sample points in the scanned image data (FIG. 9, block 102). In this process, the image reconstruction processing component 26 determines from the decoded auxiliary information 48 the pixel dimensions of the original input image 34 and the physical print size of the hard copy of the input image 34. The image reconstruction processing component 26 uses this information, along with estimates of the corner locations of the input image in the scanned image data 44, to estimate the locations of the sample points in the scanned image data that correspond to the pixel locations of the input image 34.

After the sample points have been located, the image reconstruction processing component 26 registers the input image portion of the scanned image data 44 within the estimated corner locations based on correspondences between the reference pixel values in the decoded auxiliary information 38 and the values of corresponding sample points in the scanned image data 44 (FIG. 9, block 104). In this process, the image reconstruction processing component 26 computes an error measure from the differences between the reference pixel values and the values of the corresponding sample points in the scanned image data 44.

In some embodiments, the image reconstruction processing component 26 then iteratively optimizes the estimated locations (xᵢ, yᵢ) of the corners of the input image in the scanned image data to minimize the error. For this purpose, the image reconstruction processing component 26 may use, for example, a direct search optimization process. The registration process of FIG. 9, blocks 100-104 is repeated until a specified iteration termination predicate is met (e.g., a specified number of iterations have been performed, or the measured error converges or drops below a specified threshold). During each of the iterations, the image reconstruction processing component 26 updates the estimates of the four corner locations of the input image in the scanned image data 44, re-warps and resamples the scanned image data 44 to a size equal to the pixel dimensions of the original input image 34, and re-registers the input image portion of the scanned image data within the estimated corner locations based the error between the reference pixel values and the values of the corresponding sample points in the scanned image data 44.

E. Color-Correcting the Registered Image

After the input image portion of the scanned image data 44 has been registered (FIG. 8, block 94), the image reconstruction processing component 26 derives a color transform between ones of the reference pixel values in the decoded auxiliary data structure and corresponding ones of the sample point values of the registered image (FIG. 8, block 96).

In some embodiments, the image reconstruction processing component 26 determines a transformation (T) that maps the values of the color-correction reference pixels in the decoded auxiliary information 48 to the values of the sample points at the corresponding locations in the registered image (FIG. 7, block 84). The relationship between the reference pixels and the corresponding registered image sample points is expressed mathematically in equation (6):

$$[ \begin{matrix}{R}_{ref} \\ {G}_{ref} \\ {B}_{ref}\end{matrix} ] = T \cdot [ \begin{matrix}{R}_{reg} \\ {G}_{reg} \\ {B}_{reg}\end{matrix} ] \qquad ( 5 )$$

where R_{ref}, G_{ref}, and B_{ref} represent the color values of the reference pixels in the decoded auxiliary information, and R_{reg}, G_{reg}, and B_{reg} represent the color values of the corresponding sample points of the registered image. The coefficients of the transformation T may be determined using an optimization process that minimizes the error between the reference pixel values and the values of the corresponding sample points of the registered image. In some embodiments, for each color plane, a one-dimensional lookup table that maps a color value to another is created. In the process, the range of 0-255 is sampled uniformly and for each sample point a corresponding mapped value is optimized. A monotonicity constraint is enforced during optimization. The mapping for colors that fall in between the sample points are obtained by smooth (e.g., spline) interpolation. In other embodiments, independent one-dimensional monotonic lookup tables are created for each color component, followed by either a linear transformation or a multivariate polynomial transformation.

After the color transform has been derived (FIG. 8, block 96), the image reconstruction processing component 26 applies the color transform (T) to the registered image to obtain a color-corrected output image 46 (FIG. 8, block 98).

F. Exemplary Embodiments of Improving the Reconstruction Results

In some embodiments, after the specified number of registration and color-correction iterations have been performed, the image reconstruction processing component 26 outputs the registered and color-corrected image as the output image 46.

In other embodiments, the image reconstruction processing component 26 generates the output image 46 from the coded transform coefficients in the decoded auxiliary information 48 using the registered and color-corrected image as side information. In these embodiments, a minimum mean-squared error reconstruction function is used to obtain an optimal reconstruction of a coefficient x which is received as y and whose coset index is transmitted as c.

$$\begin{matrix}\hat{x} = E ( x / y , ψ ( φ ( x , Q ) , M ) = c ) \\ = \frac{{\sum }_{q ∈ Ω : ψ ( q , M ) = c} {\int }_{{x}_{l} ( q )}^{{x}_{h} ( q )} {xf}_{X / Y} ( x , y ) d x}{{\sum }_{q ∈ Ω : ψ ( q , M ) = c} {\int }_{{x}_{l} ( q )}^{{x}_{h} ( q )} {f}_{X / Y} ( x , y ) d x}\end{matrix} \qquad ( 6 )$$

If we define:

$${m}_{1} ( x , y ) = {\int }_{- ∞}^{x} {x}^{′} {f}_{X / Y} ( {x}^{′} , y ) d {x}^{′} , \\ {m}_{0} ( x , y ) = {\int }_{- ∞}^{x} {f}_{X / Y} ( {x}^{′} , y ) d {x}^{′} \qquad ( 7 )$$

then the optimal reconstruction function can be written as:

$$\hat{x} = \frac{{\sum }_{q ∈ Ω : ψ ( q , M ) = c} \{ {m}_{1} ( {x}_{h} ( q ) , y ) - {m}_{1} ( {x}_{l} ( q ) , y ) \}}{{\sum }_{q ∈ Ω : ψ ( q , M ) = c} \{ {m}_{0} ( {x}_{h} ( q ) , y ) - {m}_{0} ( {x}_{l} ( q ) , y ) \}} \qquad ( 8 )$$

It turns out that for many realistic models for the data, such as Gaussian or Laplacian source X, with additive independent and identically distributed (i.i.d) Gaussian noise Z to yield the side information Y, the functions m0 and m1 can be readily approximated. In other cases, interpolation on pre-computed 2D look-up tables for m0 and m1 can be used to obtain the optimal reconstruction values.

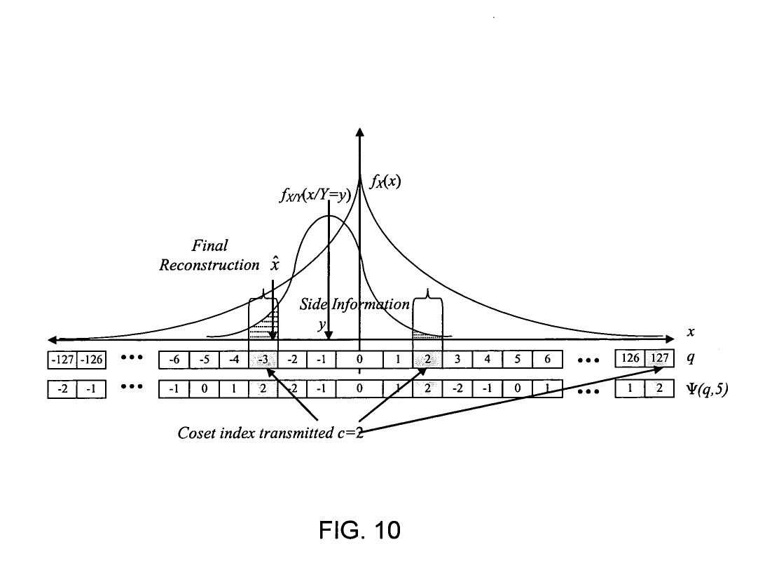

FIG. 10 shows a decoding example for a case where the coset index transmitted was 2. Given the y as shown, the final reconstruction is obtained as \hat{x} by computing equation (8) above for all bins where the transmitted coset index was 2. The ability to use this optimal reconstruction function using the side-information y enables the image reconstruction processing component 26 to use a quantization step-size that is larger than the target quality, thereby allowing bit-rate savings in the Wyner-Ziv layer.

In some embodiments the image reconstruction processing component 26 reconstructs the transform coefficients that were not included in the auxiliary information 38 (i.e., transmitted as coset index values of zero) exactly as they appear in the side-information (i.e., the registered and color-corrected image).

### V. Exemplary Implementations of the Input Image Processing System and the Scanned Image Processing System

In some exemplary embodiments, the input image processing component 10 generates the auxiliary data structure as follows:
1. Pixel size of the original digital input image and the physical size of the printed image. This information is useful for inferring the location of sample points, as well as for the auto detection of corners.
2. Luminance values of a set of Nr sub-image blocks spread all over the input image are extracted and encoded raw along with their locations and sizes. In one exemplary process for selecting the sub-image blocks, the image is divided into M2 equal-sized sub-images over a M×M grid, where M has an integer value greater than one (e.g., threee). Within each sub-image block, all non-overlapping N×N blocks (where N has an integer value greater than one, e.g., eight) are searched and the one that has the highest luminance variance is selected. The size and locations of each of the Nr=M2 blocks, along with the raw luminance data for the pixels in these blocks, are encoded into the auxiliary data structure.
3. A set of Nc single color pixels are extracted from the raw input image data either from a regular grid or from locations that are sufficiently smooth, and encoded raw along with their locations into the auxiliary data structure.
4. An optional Wyner Ziv layer, where only a few transform domain coefficients of the original image, are encoded into the auxiliary data structure after coset mapping.

In some exemplary embodiments, the scanned image processing component 12 generates the output image 46 as follows:
1. Decode the auxiliary information associated with the output image data.
2. Scan a hard copy of output image data with a high quality scanner at a resolution higher than the resolution of the original input image.
3. Obtain approximate locations of the corners of the input image in the high-resolution scan, either by running an automatic corner detection algorithm or manually.
4. Iterate over the following steps for a specified number of iterations:
   (a) Optimize over the eight values corresponding to the coordinates over the four corners, starting form the approximate ones obtained above as the initialization point, so that the error between the original Nr transmitted blocks in the side-information and the ones obtained by warping and re-sampling the scanned image is minimized. Given the set of four corner co-ordinates in scan domain, the scanned image within these corners is warped and re-sampled to a size equal to the original image size. From this warped re-sampled image, the error between the blocks transmitted in the side-information and the blocks obtained after warping the scanned image is obtained. Then a direct search optimization mechanism is used to optimize over the eight samples of the four corner pixels. The optimized samples are used to update the four corner locations.
   (b) Once the optimal four corner locations have been obtained, warp and resample the scanned image to obtain a “registered image”.
   (c) Optimize the parameters of a model for color transformation from the registered image to the original image, based on minimizing the error between the Nc color transformed registered image pixels and the original pixel values transmitted in the side information channel at the specified locations.
   (d) Once the color transformation parameters have been optimized, the entire registered image is transformed using these parameters, to obtain the color-corrected registered image.
   (e) If the specified number of iterations has been exceeded, proceed to step 5.
   (f) Transform the scanned image data using the same color transformation parameters as optimized in step 4c, and update the scanned image data with the new transformed image.
   (g) Repeat the process beginning at step 4a.
5. If a Wyner Ziv layer is included in the decoded auxiliary information, decode the Wyner-Ziv layer by channel decoding based on the registered and color-corrected image.

### VI. Conclusion

In accordance with the embodiments that are described in detail herein, auxiliary information is extracted from input digital images. The auxiliary information describes or otherwise captures features of the input image. The auxiliary information is used in reconstructing ones of the input images that have been processed through print-scan channels. As explained in detail above, the auxiliary information allows these embodiments to reconstruct high-quality approximations of the original digital input images.

Other embodiments are within the scope of the claims.

What is claimed is:

1. An image processing method, comprising:
extracting auxiliary information, including values of reference pixels, from an input image;
encoding the auxiliary information into an auxiliary data structure;
generating output image data containing a representation of the input image; and
in at least one physical storage medium, storing the auxiliary data structure in association with the output image data.

2. The method of claim 1, wherein the extracting comprises identifying pixels at regularly spaced sample locations across the input image as ones of the reference pixels.

3. The method of claim 1, wherein the extracting comprises identifying salient regions of the input image and selecting pixels in the salient regions as ones of the reference pixels.

4. The method of claim 3, wherein the identifying comprises identifying corner regions of the input image as ones of the salient regions.

5. The method of claim 3, wherein the identifying comprises applying to the input image at least one of an autocorrelation feature extractor, a variance feature extractor, and a scale-invariant feature transform to identify ones of the salient regions.

6. The method of claim 3, wherein the extracting comprises selecting blocks of pixels corresponding to the salient regions as registration reference pixel blocks, and the encoding comprises encoding luminance values of the pixels of the registration reference pixels blocks into the auxiliary data structure.

7. The method of claim 1, wherein the extracting comprises identifying regions of the input image characterized by respective texture measures that meet a specified low texture threshold and selecting pixels in the identified regions as color reference pixels, and the encoding comprises encoding color values of the color reference pixels into the auxiliary data structure.

8. The method of claim 1, wherein the extracting comprises extracting as part of the auxiliary information at least one of: pixel dimensions of the input image; and a specified print size of the input image.

9. The method of claim 1, further comprising:
generating a sequence of quantized frequency domain vectors from a sequence of blocks of the input image, wherein each of the quantized frequency domain vectors comprises a set of quantized forward transform coefficients derived from a respective block of the input image; and
calculating a respective set of coset indices from each of the frequency domain vectors;
wherein the encoding comprises encoding a respective subset of each of the sets of coset indices into the auxiliary data structure.

10. The method of claim 1, further comprising reconstructing the input image from scanned image data obtained from a hard copy of the output image data, wherein the reconstructing comprises:
decoding the auxiliary data structure associated with the output image data to produce decoded auxiliary information;
estimating locations of corners of the input image in the scanned image data;
warping the scanned image data within the estimated corner locations to obtain sample points in the scanned image data; and
registering the portion of the scanned image data within the estimated corner locations based on correspondences between the reference pixel values in the decoded auxiliary information and values of sample points at corresponding locations in the scanned image data.

11. The method of claim 10, wherein the reconstructing additionally comprises deriving a color transform between ones of the reference pixel values in the auxiliary data structure and values of corresponding ones of the sample points of the registered image, and applying the color transform to the registered image to obtain a color-corrected image.

12. The method of claim 11, further comprising generating a sequence of quantized frequency domain vectors from a sequence of blocks of the input image, wherein each of the quantized frequency domain vectors comprises a set of quantized forward transform coefficients derived from a respective block of the input image, and calculating a respective set of coset indices from each of the frequency domain vectors;
wherein the encoding comprises encoding a respective subset of each of the sets of coset indices into the auxiliary data structure, and the reconstructing comprises generating an output image from the subsets of the coset indices in the decoded auxiliary information using the color-corrected image as side information.

13. The method of claim 1, wherein the generating comprises merging the input image and the auxiliary data structure into the output image data representing a layout of the input image and the auxiliary data structure.

14. The method of claim 13, wherein the storing comprising printing the output image data onto at least one page of print media.

15. An image processing method, comprising:
obtaining scanned image data from a hard copy of output image data containing an input image;
decoding an auxiliary data structure associated with the output image data to produce decoded auxiliary information;
estimating locations of corners of the input image in the scanned image data;
warping the scanned image data within the estimated corner locations to obtain sample points in the scanned image data;
registering the portion of the scanned image data within the estimated corner locations based on correspondences between the reference pixel values in the decoded auxiliary information and values of sample points at corresponding locations in the scanned image data;
deriving a color transform between ones of the reference pixel values in the auxiliary data structure and values of corresponding ones of the sample points of the registered image; and
applying the color transform to the registered image to obtain a color-corrected image.

16. The method of claim 15, wherein the decoding comprises decoding the auxiliary data structure to obtain estimates of transform coefficients extracted from the input image, and further comprising generating an output image from the transform coefficient estimates using the color-corrected image as side information.

17. An image processing system, comprising:
an auxiliary information processing component that extracts auxiliary information, including values of reference pixels, from an input image;
an encoding processing component that encodes the auxiliary information into an auxiliary data structure; and
an output image processing component that generates output image data containing a representation of the input image;
wherein at least one of the encoding processing component and the output image processing component stores the auxiliary data structure in association with the output image data in at least one physical storage medium.

18. The system of claim 17, further comprising a scanned image processing system that reconstructs the input image from scanned image data obtained from a hard copy of the output image data, wherein the scanned image processing system comprises:
a decoding processing component that decodes the auxiliary data structure associated with the output image data to produce decoded auxiliary information;
a preprocessing stage that estimates locations of corners of the input image in the scanned image data; and
an image reconstruction processing component that warps the scanned image data within the estimated corner locations to obtain sample points in the scanned image data, and registers the portion of the scanned image data within the estimated corner locations based on correspondences between the reference pixel values in the decoded auxiliary information and values of sample points at corresponding locations in the scanned image data.

19. The system of claim 18, wherein the image reconstruction processing component additionally derives a color transform between ones of the reference pixel values in the auxiliary data structure and values of corresponding ones of the sample points of the registered image, and applies the color transform to the registered image to obtain a color-corrected image.

20. The system of claim 19, wherein:
the auxiliary information processing component generates a sequence of quantized frequency domain vectors from a sequence of blocks of the input image, each of the quantized frequency domain vectors comprising a set of quantized forward transform coefficients derived from a respective block of the input image, and calculating a respective set of coset indices from each of the frequency domain vectors;
the encoding processing component encodes a respective subset of each of the sets of coset indices into the auxiliary data structure; and
the reconstruction processing component generates an output image from the subsets of the coset indices in the decoded auxiliary information using the color-corrected image as side information.
